(19) United States
(12) Patent Application Publication
(10) Pub. No.: US 2010/0100411 A1
(43) Pub. Date: Apr. 22, 2010

(54) INFORMATION PROCESSING APPARATUS, INFORMATION PROCESSING METHOD, AND RECORDING MEDIUM

(76) Inventor: Seiji SAWAGUCHI, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/574,882

(22) Filed: Oct. 7, 2009

(30) Foreign Application Priority Data
Oct. 16, 2008 (JP) 2008-267416

(51) Int. Cl. G06Q 10/00

(52) U.S. Cl. 705/8

(57) ABSTRACT

Master equipment information including cost-related information on an information equipment that is recommendable as a substitute for the information equipment managed by an equipment managing server is stored in a master information memory unit. An equipment information collecting unit collects equipment information from the equipment managing server. A comparative analysis unit compares the equipment information collected by the equipment information collecting unit with the cost-related information included in the master equipment information, and specifies an information equipment that enables achieving cost reduction with respect to the information equipment managed by the equipment managing server as a recommendable information equipment.

### CROSS-REFERENCE TO RELATED APPLICATIONS

The present application claims priority to and incorporates by reference the entire contents of Japanese Patent Application No. 2008-267416 filed in Japan on Oct. 16, 2008.

### BACKGROUND OF THE INVENTION

1. Field of the Invention

The present invention relates to a technology for obtaining operating information about an information equipment.

2. Description of the Related Art

In recent years, how to achieve reduction in the total cost of ownership (TCO) has been an important issue for companies in implementing, maintaining, and managing computer systems. Form that aspect, it has become imperative for the companies to figure out suitable computer systems or information equipments that fit in the respective company environments.

In that context, a variety of computer systems or information equipments have been disclosed that enable achieving cost reduction. For example, Japanese Patent Application Laid-open No. 2003-58698 discloses a technology in which, if a company sends information on items that are considered burden on system expenses or personnel expenses (e.g., volume of sent/received e-mails, telephone usage time, and transportation expenses) to a certain website, then the website offers a suggestion to reduce the cost burden and optimize the information technology (IT) environment of that company.

However, in the technology disclosed in Japanese Patent Application Laid-open No. 2003-58698, the prerequisite is that the items for cost reduction need to be determined and specified by a company. That causes an increase in the workload of that company. Moreover, even when information equipments such as printers that are suitable to the IT environment of a company are to be installed or when existing information equipments are to be upgraded to a suitable configuration, then it is the task of that company to input identification information such as model numbers of the pertinent information equipments and give due consideration to the service life or the depreciation period before deciding on installation or upgrade. In this way, the company is forced to perform the cumbersome tasks.

### SUMMARY OF THE INVENTION

It is an object of the present invention to at least partially solve the problems in the conventional technology.

According to an aspect of the present invention, there is provided an information processing apparatus that is connected to an equipment managing server via a communication network and that analyzes equipment information on an information equipment managed by the equipment managing server. The information processing apparatus includes a master information memory unit configured to store therein master equipment information including cost-related information on an information equipment that is recommendable as a substitute for the information equipment managed by the equipment managing server; an equipment information collecting unit configured to collect the equipment information from the equipment managing server; and a comparative analysis unit configured to compare the equipment information collected by the equipment information collecting unit with the cost-related information included in the master equipment information, and specify an information equipment that enables achieving cost reduction with respect to the information equipment managed by the equipment managing server as a recommendable information equipment.

According to another aspect of the present invention, there is provided an information processing method performed in an information processing system that includes an equipment managing server that manages an information equipment and equipment information on the information equipment, an equipment analysis server that analyzes the equipment information managed by the equipment managing server, the equipment managing server and the equipment analysis server being connected to each other via a communication network. The information processing method includes the equipment analysis server collecting the equipment information from the information equipment; the equipment analysis server sending collected equipment information to the equipment analysis server; the equipment analysis server storing, in a master information memory unit, master equipment information that includes cost-related information on an information equipment that is recommendable as a substitute for the information equipment managed by the equipment managing server; the equipment analysis server receiving the equipment information from the equipment managing server; and the equipment analysis server specify an information equipment that enables achieving cost reduction with respect to the information equipment managed by the equipment managing server as a recommendable information equipment by comparing the equipment information received at the collecting with the cost-related information stored in the master information memory unit.

According to still another aspect of the present invention, there is provided a computer-readable recording medium that stores therein a computer program that causes a computer to implement the above information processing method.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of an information processing system according to an embodiment of the present invention;

FIG. 2 is a functional block diagram of an equipment managing server shown in FIG. 1;

FIG. 3 is a schematic diagram of exemplary equipment information stored in a memory unit shown in FIG. 2;

FIG. 4 is a functional block diagram of an equipment analysis server shown in FIG. 1;

FIG. 5 is a schematic diagram of exemplary master equipment information stored in a master information memory unit shown in FIG. 4;

FIG. 6 is a schematic diagram of exemplary client equipment information stored in the master information memory unit shown in FIG. 4;

FIG. 7 is a schematic diagram of exemplary recommendable equipment information stored in the master information memory unit shown in FIG. 4;

FIG. 8 is a graph of an exemplary amount of power consumption calculated using predetermined formulae;

FIG. 9 is a bar graph of exemplary statistical information output by a comparative analysis unit shown in FIG. 4; and

FIG. 10 is a sequence diagram of an exemplary sequence of operations performed in the information processing system shown in FIG. 1.

### DETAILED DESCRIPTION OF THE PREFERRED EMBODIMENTS

Exemplary embodiments of the present invention are described in detail below with reference to the accompanying drawings. The present invention is not limited to these exemplary embodiments.

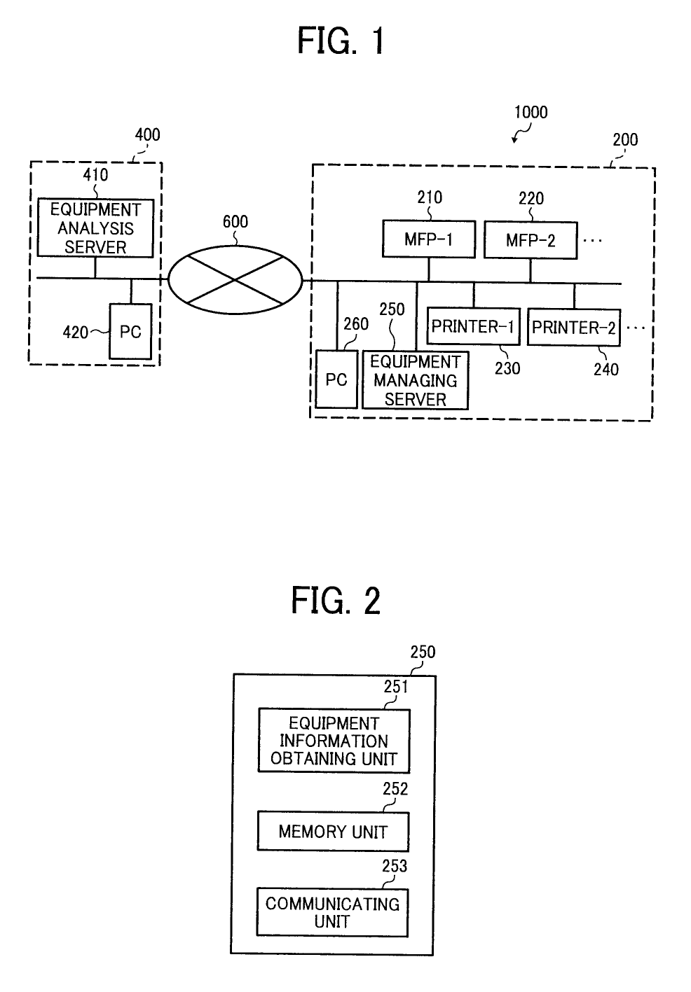

FIG. 1 is a block diagram of an information processing system 1000 according to an embodiment of the present invention. The information processing system 1000 includes a company system 200 administered by a company A, an analysis system 400 administered by a company B, and a communication network 600.

The company system 200 represents a standard computer system and it is implemented by a company network such as a local area network (LAN) within the company A. The company system 200 includes information equipments such as multifunction products (MFPs) 210 and 220, printers 230 and 240, an equipment managing server 250, and a personal computer (PC) 260. In addition, the company system 200 can also include other information equipments such as servers installed in each department of the company A or personal computers used by the employees of the company A.

It is assumed that the each of the MFPs 210 and 220 and the printers 230 and 240 is installed in separate departments of the company A. Thus, the employees in each department use the corresponding MFP or the printer to, for example, make copies of documents, or perform external facsimile (FAX) communication.

In each of the MFPs 210 and 220 and the printers 230 and 240, an engine (not shown) obtains a variety of information on the condition of the corresponding information equipment (hereinafter, “equipment information”) and stores it in a memory (not shown). The equipment information includes, for example, read rate, first print time, transition time from a standby mode to a preheat mode (hereinafter, “preheat mode transition time”), transition time from the standby mode to a power-OFF mode (hereinafter, “power-OFF mode transition time”), transition time from the standby mode to a sleep mode (hereinafter, “sleep mode transition time”), typical electricity consumption (TEC) value, number of printed sheets, average print rate, percentage of residual toner, and amount of carbon dioxide (CO2) emissions.

As described later in detail, the equipment managing server 250 obtains the equipment information on the MFPs 210 and 220 and the printers 230 and 240 at a predetermined timing and sends it to the analysis system 400.

The TEC value is indicative of the amount of power consumption of an information equipment when the information equipment repeatedly switches between an operating mode and a sleep/power-OFF mode for five days and remains in the sleep/power-OFF mode for two days. That is, on a conceptual basis, the TEC value is indicative of the amount of power consumption for a single five-day business week. Thus, a small TEC value indicates that the power consumption of the information equipment is low.

The equipment managing server 250 manages the equipment information on the information equipments in the company system 200 of the company A. FIG. 2 is a functional block diagram of the equipment managing server 250.

The equipment managing server 250 includes an equipment information obtaining unit 251, a memory unit 252, and a communicating unit 253.

The equipment information obtaining unit 251 obtains the equipment information stored in each of the MFPs 210 and 220 and the printers 230 and 240 at a predetermined timing and stores it in the memory unit 252. It is assumed for the sake of convenience that the equipment information obtaining unit 251 obtains equipment information once every month (e.g., at each month end).

When an equipment analysis server 410 in the analysis system 400 issues a request for receiving certain equipment information to the company system 200, the equipment information obtaining unit 251 in the company system 200 receives the request, retrieves corresponding equipment information from the memory unit 252, and sends it to the equipment analysis server 410.

In addition, as described later in detail, the company system 200 receives from the analysis system 400 statistical information indicating a result of statistical analysis of the equipment information that the company system 200 had sent to the equipment analysis server 400.

The memory unit 252 is a recording medium such as a hard disk drive (HDD) that is used to store all or a part of the equipment information obtained by the equipment information obtaining unit 251.

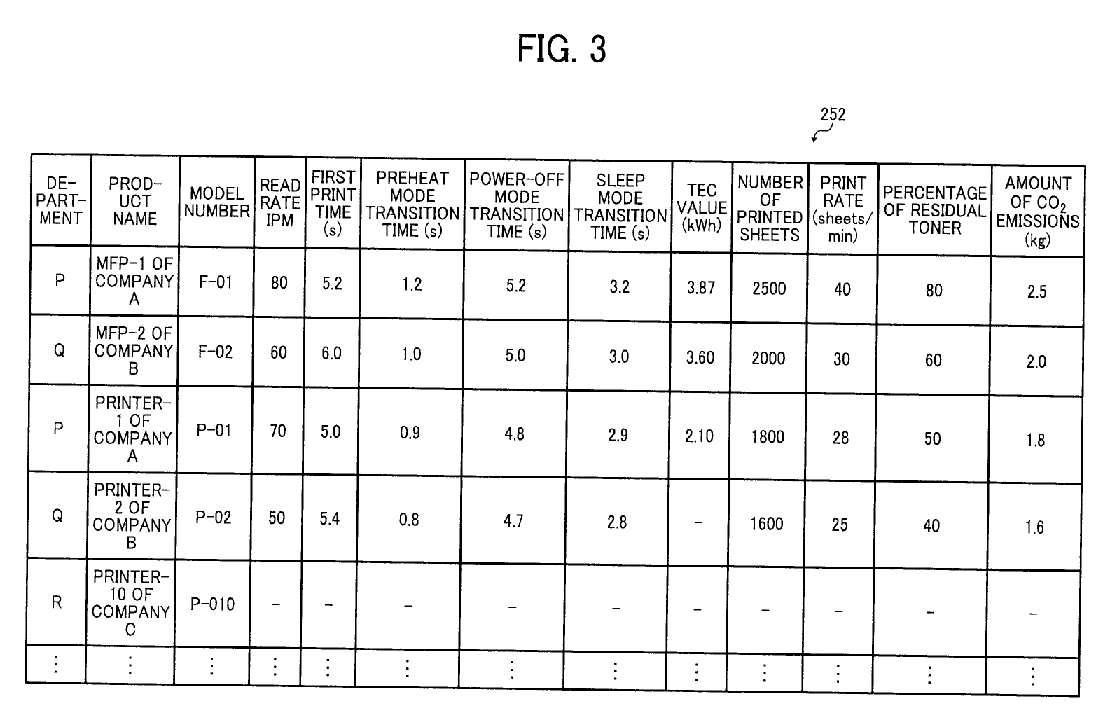

FIG. 3 is a schematic diagram of exemplary equipment information stored in the memory unit 252. As shown in FIG. 3, the equipment information stored in the memory unit 252 includes the equipment information on the information equipments in the company system 200. The equipment information stored in the memory unit 252 includes following items: product name, model number, read rate, first print time, preheat mode transition time, power-OFF mode transition time, sleep mode transition time, TEC value, number of printed sheets, average print rate, percentage of residual toner, and amount of carbon dioxide (CO2) emissions.

For example, the equipment information on an MFP-1 (product name) that is a product of a company A, which is set in a department P of the company A, indicates that the model number is F-01, the read rate is 80 images per minute (IPM), the first print time is 5.2 seconds, the preheat mode transition time is 1.2 seconds, the power-OFF mode transition time is 5.2 seconds, the sleep mode transition time is 3.2 seconds, and the TEC value is 3.87 kilowatt-hour (kWh).

In comparison, in the equipment information on a printer-2 (product name) that is a product of a company B, which is set in a department Q of the company A, the TEC value is not included. Moreover, in the equipment information on a printer-10 (product name) that is a product of a company C, which is set in a department R of the company A, only the product name and the model number are included. Thus, the equipment information on a particular information equipment may or may not include information about some of the abovementioned items. That is because, depending on the time of purchasing, there is a possibility that a purchased MFP or a purchased printer is not configured to enable calculation of the TEC value or enable retrieval and calculation of the first print time or the preheat mode transition time.

In the equipment managing server 250, the communicating unit 253 is made of a communication equipment such as a network board that enables communication between the equipment managing server 250 and the information equipments of the company system 200 as well as communication between the equipment managing server 250 and the information equipments of the analysis system 400.

The PC 260 is a personal computer operated by the employees using the company system 200 or the administrators of the company system 200. The PC 260 can be used to refer to the statistical information that the equipment information obtaining unit 251 receives from the analysis system 400. Referring to the statistical information allows the employees/administrators to contemplate replacement/purchase of information equipments.

The analysis system 400 is used to analyze the equipment information on the information equipments connected to the company system 200 and generate the statistical information. The analysis system 400 includes the equipment analysis server 410 and a PC 420.

The equipment analysis server 410 is an information processing apparatus such as a server that analyzes the equipment information received from the company system 200.

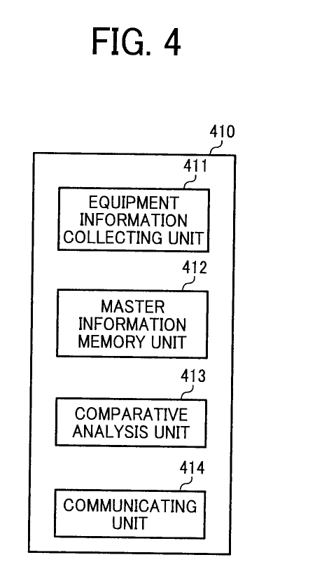

FIG. 4 is a functional block diagram of the equipment analysis server 410. As shown in FIG. 4, the equipment analysis server 410 includes an equipment information collecting unit 411, a master information memory unit 412, a comparative analysis unit 413, and a communicating unit 414.

The equipment information collecting unit 411 requests the equipment managing server 250 to send certain equipment information stored in the memory unit 252. Upon receiving the requested equipment information, the equipment information collecting unit 411 stores it in the master information memory unit 412. It is assumed for the sake of convenience that the equipment information collecting unit 411 issues such a request at a predetermined timing, in a similar manner to the equipment information obtaining unit 251 that obtains equipment information at a predetermined timing.

The master information memory unit 412 is a recording medium such as an HDD that is basically used to store information possessed by the company B on catalog values of performance (hereinafter, “master equipment information”) of information equipments (e.g., MFPs, printers).

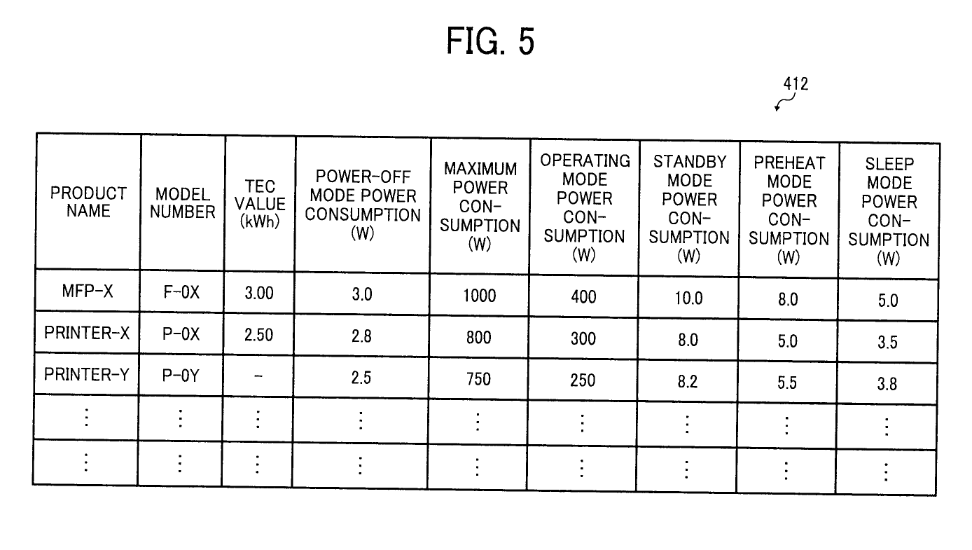

FIG. 5 is a schematic diagram of exemplary master equipment information stored in the master information memory unit 412. As shown in FIG. 5, the master equipment information includes following items: product name, model number, TEC value, power consumption in the power-OFF mode (i.e., when only the main power supply is ON) (hereinafter, “power-OFF mode power consumption”), maximum power consumption, power consumption during printing or facsimileing operations (hereinafter, “operating mode power consumption”), power consumption in the standby mode (hereinafter, “standby mode power consumption”), power consumption in the preheat mode (hereinafter, “preheat mode power consumption”), and power consumption in the sleep mode (hereinafter, “sleep mode power consumption”).

For example, the master equipment information on an MFP-X (product name) indicates that the model number is F-0X, the TEC value is 3.00 kWh, the power-OFF mode power consumption is 3.0 watt (W), the maximum power consumption is 1000 W, the operating mode power consumption is 400 W, the standby mode power consumption is 10.0 W, the preheat mode power consumption is 8.0 W, and the sleep mode power consumption is 5.0 W.

In comparison, in the master equipment information on a printer-Y (product name), the TEC value is not included. That is because, depending on the time of product development, there is a possibility that the TEC value cannot be calculated, as may be the case regarding the equipment managing server 250 in the company system 200.

Herein, the master equipment information is information mainly on the amount of power consumption in various modes. Alternatively, the master equipment information can also be configured as information on various equipment performances such as product life, noise level, dimensions, and HDD capacity.

Apart from the master equipment information, the master information memory unit 412 is used to store equipment information on information equipments of various other companies (hereinafter, “client equipment information”).

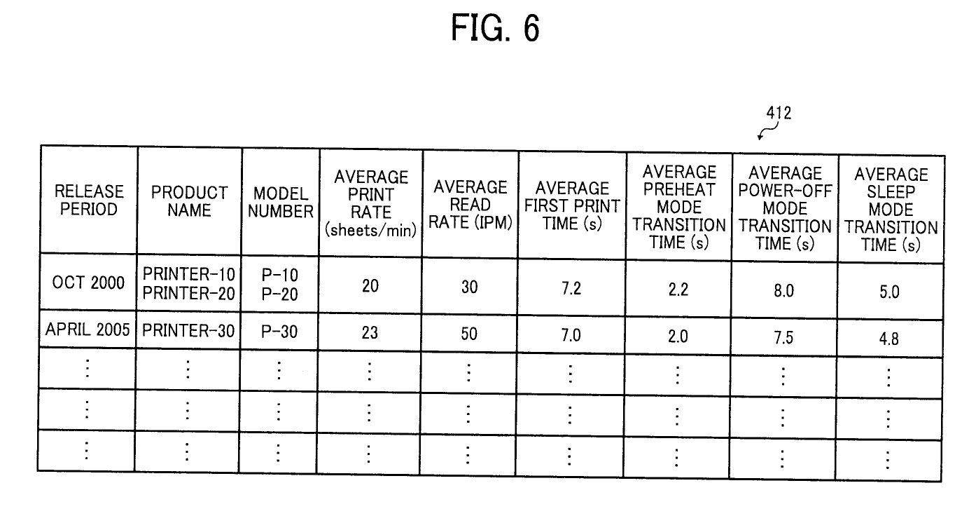

FIG. 6 is a schematic diagram of exemplary client equipment information stored in the master information memory unit 412. The client equipment information includes following items: release period (year and month) of various information equipments; product name and model number of each information equipment corresponding to each release period; and average print rate, average read rate, average first print time, average preheat mode transition time, average power-OFF mode transition time, and average sleep mode transition time of each information equipment released in each release period. Herein, it is assumed that the client equipment information is calculated in advance by the employees of the company B.

The comparative analysis unit 413 compares the equipment information received from the company system 200 with the master equipment information stored in the master information memory unit 412 and determines whether there are any information equipments in the master equipment information that can be recommended to the company A as an upgrade over existing information equipments possessed by the company A. The equipment information on the recommendable information equipment (hereinafter, “recommendable equipment information”) is separately stored in the master information memory unit 412. Thus, the recommendable equipment information represents the equipment information on information equipments that can substitute for the existing information equipments possessed by the company A.

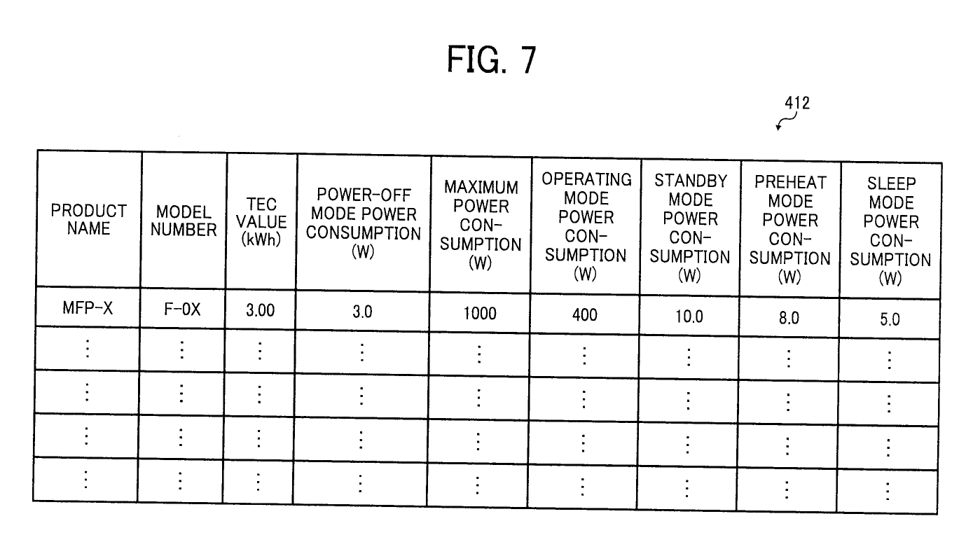

FIG. 7 is a schematic diagram of exemplary recommendable equipment information. The recommendable equipment information includes the equipment information of only those information equipments which the comparative analysis unit 413 determines to be recommendable to the company A. In the present embodiment, the items in the recommendable equipment information are identical to the items in the master equipment information. Alternatively, it is also possible to store information such as product life, noise level, dimensions, and HDD capacity as the recommendable equipment information.

When the equipment information collecting unit 411 receives certain equipment information from the company system 200 and stores it in the master information memory unit 412, the comparative analysis unit 413 refers to the master information memory unit 412, compares the equipment information of the company system 200 with the master equipment information, and identifies the information equipments of identical model types.

More particularly, for example, the comparative analysis unit 413 refers to the model number F-01 in the equipment information of the company system 200 shown in FIG. 3. Then, the comparative analysis unit 413 searches for an information equipment having the model number starting with “F-” in the master equipment information and identifies that information equipment to have an identical model type to the information equipment having the model number F-01.

Subsequently, the comparative analysis unit 413 determines whether the TEC value is included in the master equipment information on the identified information equipment having the model number starting with “F-”. If the TEC value is included, then the comparative analysis unit 413 determines whether that TEC value is smaller than the TEC value of the information equipment having the model number F-01.

If the TEC value of the information equipment having the model number starting with “F-” is smaller than the TEC value of the information equipment having the model number F-01, then the comparative analysis unit 413 stores the equipment information on the information equipment having the model number starting with “F-” (e.g., product name: MFP-X, model number: F-0X) as the recommendable equipment information in the master information memory unit 412. In this way, the information equipment having the product name MFP-X and the model number F-0X is determined to be recommendable to the company A as an upgrade over the existing information equipment having the product name MFP-1 and the model number F-01 possessed by the company A.

Meanwhile, if the TEC value is not included in the master equipment information on the identified information equipment having the model number starting with “F-”, then the comparative analysis unit 413 determines whether information other than the TEC value (e.g., first print time, preheat mode transition time, power-OFF transition time, or sleep-mode transition time) is included in the master equipment information on that information equipment. If such information is not included, the comparative analysis unit 413 calculates the amount of power consumption using the included information and predetermined formulae. The amount of power consumption is used as an alternative to the TEC value for the comparison purpose.

For example, consider a case when a single printing operation in a printer (or an MFP) includes three periods, namely, an initial activation period T0 in which components such as the engine are activated, a printing period T1 for warming up and printing, and a power-OFF period T2 in which the printer gradually makes transition into the power-OFF mode after the printing is complete. In that case, if it is assumed that the amount of power consumption required to activate the components during the initial activation period T0 is constant, then the amount of power consumption during the printing period T1 and the power-OFF period T2 can be calculated as given below.

The amount of power consumption during the printing period T1 can be calculated as, for example, “(first print time)×(maximum power consumption)+(read rate)×(operating mode power consumption)”. Thus, with reference to the above example, if the TEC value is not included in the master equipment information on the identified information equipment having the model number starting with “F-”, then the comparative analysis unit 413 calculates the amount of power consumption during the printing period T1 using the first print time (5.2 seconds) and the read rate (80 IPM) from the equipment information on the information equipment having the model number F-01 and using the maximum power consumption (1000 watt) and the operating mode power consumption (400 watt) from the master equipment information on the identified information equipment having the model number starting with “F-”.

Similarly, the amount of power consumption during the power-OFF period T2 can be calculated as, for example, “Min(preheat mode transition time, predetermined non-print time)×(standby mode power consumption)+Min(power-OFF mode transition time, (predetermined non-print time)−(preheat mode transition time))×(preheat mode transition time)+Min(sleep mode transition time, (predetermined non-print time)−(preheat mode transition time)−(power-OFF mode transition time))×(power-OFF mode transition time)+Max(0, (predetermined non-print time)−(preheat mode transition time)−(power-OFF mode transition time)−(sleep mode transition time))×(sleep mode transition time)”. To calculate the amount of power consumption during the power-OFF period T2, the comparative analysis unit 413 obtains the necessary values from the equipment information received from the company system 200 and the master equipment information stored in the master information memory unit 412.

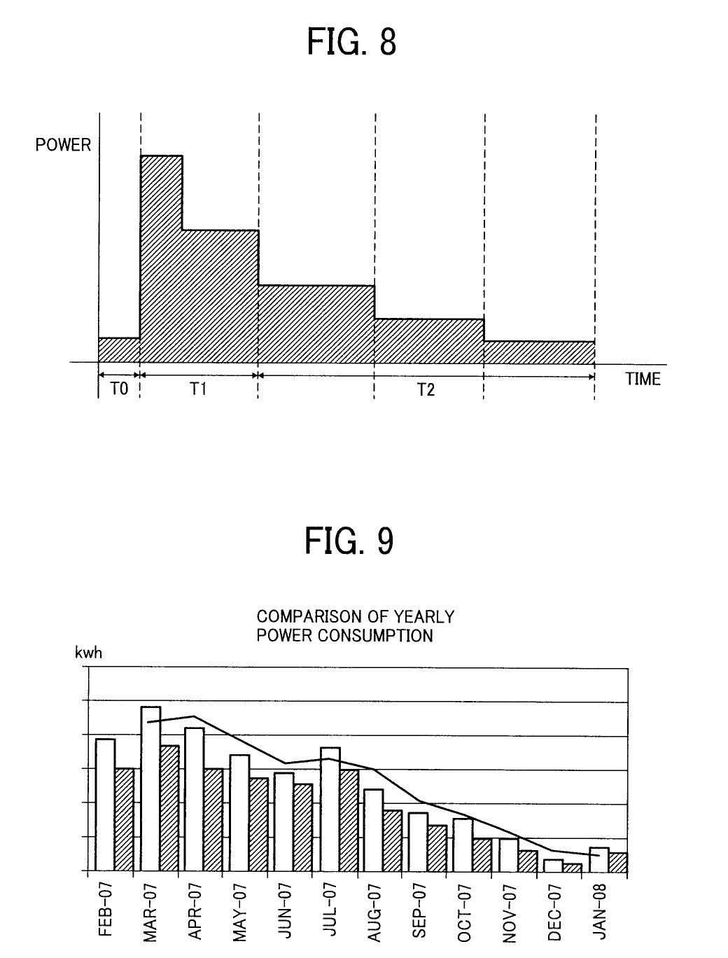

The amount of power consumption during a single printing operation can be depicted as, for example, an area filled with hatched lines in FIG. 8, where the vertical axis represents power and the horizontal axis represents time.

Subsequently, the comparative analysis unit 413 converts the calculated amount of power consumption during the single printing operation into the amount of power consumption for a single five-day business week. That amount of power consumption acts as a reference for the TEC value. If the amount of power consumption of the information equipment included in the master equipment information is smaller than the amount of power consumption of the information equipment included in the equipment information received from the company system 200, the comparative analysis unit 413 stores that master equipment information as the recommendable equipment information in the master information memory unit 412.

Meanwhile, if neither the TEC value nor information other than the TEC value is included in the equipment information received from the company system 200, then the comparative analysis unit 413 refers to the client equipment information stored in the master information memory unit 412 and obtains therefrom the average read rate, the average first print time, the average preheat mode transition time, the average power-OFF mode transition time, and the average sleep mode transition time as substitute information for the equipment information received from the company system 200. Then, the comparative analysis unit 413 calculates the amount of power consumption for a single printing operation using the abovementioned formulae and converts the calculated amount of power consumption into the amount of power consumption for a single five-day business week. That amount of power consumption acts as a reference for the TEC value. Finally, if the amount of power consumption of the information equipment included in the master equipment information is smaller than the amount of power consumption calculated from the client equipment information, the comparative analysis unit 413 stores that master equipment information as the recommendable equipment information in the master information memory unit 412.

Upon storing the recommendable equipment information in the master information memory unit 412, the comparative analysis unit 413 refers to the equipment information received from the company system 200 and outputs statistical information. The statistical information represents periodic differences in the amount of power consumption between the information equipment included in the recommendable equipment information and the information equipment having the same model type included in the equipment information received from the company system 200. FIG. 9 is a bar graph of exemplary statistical information output by the comparative analysis unit 413. That is, in FIG. 9, the differences in the amount of power consumption (un-hatched bars: pre-recommendation amount of power consumption, hatched bars: post-recommendation amount of power consumption) for each month throughout a year is depicted in the form of a bar graph.

Thus, the comparative analysis unit 413 stores the recommendable equipment information in the master information memory unit 412 and then sends predetermined statistical information to the company system 200 at a predetermined interval. However, depending on the model type or the cost of a recommendable information equipment, the sales staff of the company B may need to use the statistical information or comparison of the equipment information of a plurality of model types as the material for presentation at the time of visiting the company A for equipment recommendation. In such a case, instead of sending the statistical information to the company system 200, the comparative analysis unit 413 temporarily stores, for example, a variety of recommendable equipment information in the master information memory unit 412 as a data warehouse.

Thus, in the master information memory unit 412 is stored the recommendable equipment information on a plurality of information equipments having the same model types to the model types included in the equipment information received from the company system 200. Subsequently, the employees of the company B can make use of, for example, a data mining tool on the PC 420 for referring to the recommendable equipment information stored in the master information memory unit 412, perform multifaceted information analysis of the recommendable equipment information, and then output the analysis result as statistical information.

With reference to FIG. 4, the communicating unit 414 is made of a communication equipment such as a network board that enables communication between the equipment analysis server 410 and the PC 420 in the analysis system 400 and communication between the equipment analysis server 410 and the company system 200.

The PC 420 is a personal computer connected to a company network of the company B and operated by the employees of the company B. The employees of the company B refer to the recommendable equipment information using the PC 420 and analyze which information equipments are suitable for the company A.

The communication network 600 is a communication line such as Internet or a wide area network (WAN) via which the company system 200 and the analysis system 400 perform communication.

Given below is an exemplary sequence of operations performed in the information processing system 1000.

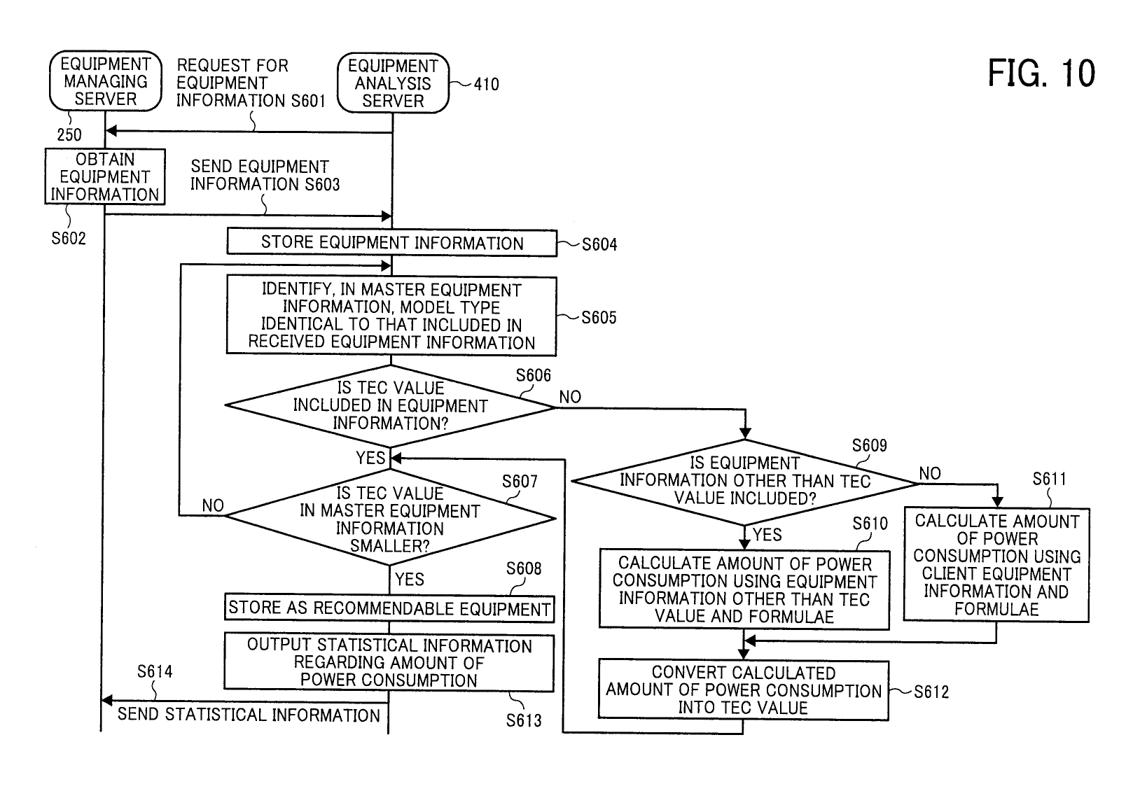

FIG. 10 is a sequence diagram of an exemplary sequence of operations performed by the equipment analysis server 410. The sequence of operations starts with obtaining the equipment information of the company system 200 and ends with outputting the recommendable equipment information to the company system 200.

First, the equipment information collecting unit 411 in the equipment analysis server 410 requests the equipment managing server 250 to send certain equipment information of the company system 200 (Step S601). Then, the equipment information obtaining unit 251 in the equipment managing server 250 obtains the requested equipment information from the memory unit 252 (Step S602) and sends it to the equipment analysis server 410 (Step S603).

Upon receiving the requested equipment information, the equipment information collecting unit 411 stores it in the master information memory unit 412 (Step S604).

The comparative analysis unit 413 compares the equipment information received from the company system 200 with the master equipment information also stored in the master information memory unit 412 (Step S605).

Then, the comparative analysis unit 413 identifies an information equipment in the master information equipment that has an identical model type to that included in the equipment information received from the company system 200 and determines whether the TEC value is included in the master equipment information on the identified information equipment (Step S606).

If the TEC value is included (Yes at Step S606), then the comparative analysis unit 413 determines whether that TEC value is smaller than the corresponding TEC value included in the equipment information received from the company system 200 (Step S607).

If the TEC value of the identified information equipment is smaller than the TEC value included in the equipment information received from the company system 200 (Yes at Step S607), then the comparative analysis unit 413 stores the equipment information on the identified information equipment as the recommendable equipment information in the master information memory unit 412 (Step S608).

On the other hand, if the TEC value of the identified information equipment is not smaller than the TEC value included in the equipment information received from the company system 200 (No at Step S607), then the system control returns to Step S605 for equipment identification.

Meanwhile, if the TEC value is not included in the master equipment information on the identified information equipment (No at Step S606), then the comparative analysis unit 413 determines whether information other than the TEC value is included in the master equipment information on that information equipment (Step S609).

If such other information is included (Yes at Step S609), then the comparative analysis unit 413 calculates the amount of power consumption using the included information and predetermined formulae (Step S610). The amount of power consumption is used as an alternative to the TEC value for the comparison purpose.

If neither the TEC value nor information other than the TEC value is included, the comparative analysis unit 413 calculates the amount of power consumption using predetermined formulae and the client equipment information, which is stored in the master information memory unit 412 as substitute information for the equipment information received from the company system 200 (Step S611). Then, the comparative analysis unit 413 converts the amount of power consumption calculated at Step S610 or Step S611 into the TEC value (Step S612).

Subsequently, the comparative analysis unit 413 outputs statistical information regarding the recommendable equipment information stored at Step S608 (Step S613) and sends the statistical information to the equipment managing server 250 (Step S614). That completes a single sequence of operations.

Thus, according to the present embodiment, the recommendable equipment information indicating information equipments that can be recommended for substitution is stored in the master information memory unit 412. The equipment information collecting unit 411 receives the equipment information from the equipment managing server 250. The comparative analysis unit 413 compares the cost-related information included in the equipment information received by the equipment information collecting unit 411 with the cost-related information included in the recommendable equipment information and identifies one or more information equipments that can be recommended as environment-specific and suitable cost-cutting measures to the company A. Thus, the company A is relieved from the cumbersome task of determining suitable information equipments for upgrade.

In the present embodiment, the description regarding the equipment analysis server 410 and the equipment managing server 250 is given on the premise that a TEC value is included as part of equipment information. However, consider a case when it is known that the equipment managing server 250 does not obtain a TEC value. In that case, only the equipment analysis server 410 can be configured to store a TEC value and calculate the amount of power consumption with the use of the equipment information received from the equipment managing server 250 and the predetermined formulae. Then, the equipment analysis server 410 can convert the calculated amount of power consumption into a TEC value and compare it with the stored TEC value. In other words, Step S606 shown in FIG. 10 is not performed and, after performing Steps S609 to S612, the comparison between the calculated TEC value and the stored value can be performed at Step S607.

Moreover, as shown in FIG. 3, it is assumed that the equipment information obtained by the equipment managing server 250 includes the amount of CO2 emissions during printing. However, since usually the amount of CO2 emissions is calculated based on the amount of power consumption, the equipment analysis server 410 can be configured to calculate the amount of CO2 emissions and use the amount of power consumption as well as the amount of CO2 emissions for the comparison purpose. That enables the equipment analysis server 410 to identify a recommendable information equipment in a more detailed manner. Thus, as compared to the case in which only the amount of power consumption is used for comparison, it becomes possible to identify a recommendable information equipment that matches the user needs in a more comprehensive way.

Meanwhile, a computer program executed in the equipment analysis server 410 according to the present embodiment can be installed in advance in a read only memory (ROM). Alternatively, the computer program executed in the equipment analysis server 410 according to the present embodiment can be provided in the form of an installable or executable file on a computer-readable storage device such as a compact disk read only memory (CD-ROM), a flexible disk (FD), a compact disk recordable (CD-R), or a digital versatile disk (DVD).

Moreover, the computer program executed in the equipment analysis server 410 according to the present embodiment can be saved as a downloadable file on a personal computer connected to a network such as Internet or can be made available for distribution through the network.

The computer program executed in the equipment analysis server 410 according to the present embodiment contains modules for the equipment information collecting unit 411, the master information memory unit 412, the comparative analysis unit 413, and the communicating unit 414. In practice, a central processing unit (CPU) retrieves the computer program from the storage device and runs it such that the computer program is loaded in a corresponding main memory. As a result, the modules for the equipment information collecting unit 411, the master information memory unit 412, the comparative analysis unit 413, and the communicating unit 414 are generated in the main memory.

Meanwhile, in the present embodiment, MFPs and printers are given as examples of information equipments. However, the present invention is also applicable to other equipments such as copying machines, facsimileing machines, and the like from which it is possible to calculate the amount of power consumption or the amount of CO2 emissions.

More particularly, as long as an equipment can provide equipment information for calculation of the amount of power consumption or the amount of CO2 emissions (e.g., a fluorescent light, a refrigerator, a television set, a home electric appliance such as an air conditioner, or an electric appliance such as a PC or an HDD), then the equipment analysis server 410 or the equipment managing server 250 can be used to obtain the equipment information and calculate the amount of power consumption as described above. Meanwhile, the apparatus that obtains the equipment information need not be an information processing apparatus such as the equipment analysis server 410 or the equipment managing server 250. Instead, for example, a wattmeter can be disposed in the company B for obtaining the equipment information or calculating the amount of power consumption.

Thus, by obtaining the equipment information such as the amount of power consumption or the amount of CO2 emissions indicating the operating state of equipments such as image forming apparatuses (e.g., an MFP), home electric appliances, or electric appliances usually installed in an office, it becomes possible to perform collective support and recommendations regarding TCO. Moreover, in addition to calculating the amount of power consumption for each equipment on an individual basis, it is also possible to calculate the amount of power consumption for a plurality of equipments (e.g., a plurality of printers in an office, or a combination of printers and a connected PC). That enables calculation of the amount of power consumption for, for example, an entire floor of an office or an entire office. As a result, support and recommendations for reducing the total TCO of an entire floor or an entire office becomes possible.

In this way, according to an aspect of the present invention, it is possible to recommend equipments suitable to a system environment of a client company, while relieving the client company from the cumbersome task of determining suitable information equipments.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus that is connected to an equipment managing server via a communication network and that analyzes equipment information on an information equipment managed by the equipment managing server, the information processing apparatus comprising:
a master information memory unit configured to store therein master equipment information including cost-related information on an information equipment that is recommendable as a substitute for the information equipment managed by the equipment managing server;
an equipment information collecting unit configured to collect the equipment information from the equipment managing server; and
a comparative analysis unit configured to compare the equipment information collected by the equipment information collecting unit with the cost-related information included in the master equipment information, and specify an information equipment that enables achieving cost reduction with respect to the information equipment managed by the equipment managing server as a recommendable information equipment.

2. The information processing apparatus according to claim 1, wherein the cost-related information indicates information on amount of power consumption.

3. The information processing apparatus according to claim 2, wherein the information on amount of power consumption is a typical electricity consumption (TEC) value.

4. The information processing apparatus according to claim 3, wherein the comparative analysis unit determines whether a TEC value is included in the equipment information collected by the equipment information collecting unit and, if the TEC value is not included, calculates an amount of power consumption according to an operating stage of either one of the information equipment managed by the equipment managing server or the recommendable information equipment.

5. The information processing apparatus according to claim 4, wherein an operating stage of either one of the information equipment managed by the equipment managing server or the recommendable information equipment includes an initial stage that is a pre-operation stage, an operation performing stage in which an operation is performed, and a post-operation stage that is a stage after the operation is complete.

6. The information processing apparatus according to claim 1, wherein
the master information memory unit stores therein information for calculating amount of power consumption of either one of the information equipment managed by the equipment managing server and the recommendable information equipment, and
the comparative analysis unit determines whether the equipment information collected by the equipment information collecting unit includes information on amount of power consumption of the information equipment managed by the equipment managing server and, if information on amount of power consumption of the information equipment managed by the equipment managing server is not included in the equipment information, compares the information for calculating amount of power consumption stored in the master information memory unit with the cost-related information on the recommendable information equipment included in the master equipment information.

7. The information processing apparatus according to claim 1, wherein the comparative analysis unit generates statistical information that is cost-related information on the recommendable information equipment collected through time and sends the statistical information to the equipment managing server.

8. An information processing method performed in an information processing system that includes an equipment managing server that manages an information equipment and equipment information on the information equipment, an equipment analysis server that analyzes the equipment information managed by the equipment managing server, the equipment managing server and the equipment analysis server being connected to each other via a communication network, the information processing method comprising:
the equipment analysis server collecting the equipment information from the information equipment;
the equipment analysis server sending collected equipment information to the equipment analysis server;
the equipment analysis server storing, in a master information memory unit, master equipment information that includes cost-related information on an information equipment that is recommendable as a substitute for the information equipment managed by the equipment managing server;
the equipment analysis server receiving the equipment information from the equipment managing server; and
the equipment analysis server specify an information equipment that enables achieving cost reduction with respect to the information equipment managed by the equipment managing server as a recommendable information equipment by comparing the equipment information received at the collecting with the cost-related information stored in the master information memory unit.

9. A computer-readable recording medium that stores therein a computer program that causes a computer to implement the information processing method according to claim 8.
